(19) United States
(12) Patent Application Publication
(10) Pub. No.: US 2026/0090499 A1
(43) Pub. Date: Apr. 2, 2026

(54) COMBINE HARVESTER WITH A DISTRIBUTOR FOR RESIDUE MATERIAL

(71) Applicant: Deere & Company, Moline, IL (US)

(72) Inventors: MARTIN FRANZ UNTERPAINTNER, Saarbrücken (DE); MARTIN RITTERSHOFER, Zweibrücken (DE)

(21) Appl. No.: 19/227,580

(22) Filed: Jun. 4, 2025

(30) Foreign Application Priority Data
Oct. 1, 2024 (DE) 102024128415.3

(51) Int. Cl. A01D 41/127; A01D 41/12

(52) U.S. Cl. CPC A01D 41/127; A01D 41/1243

(57) ABSTRACT

An example combine harvester may be equipped with a harvester head (110) and a threshing and separating assembly. Crop picked up from a field can be fed to the threshing and separating assembly via the harvester head (110). The example combine harvester may also include a straw chopper (124) configured to process residual material that is discharged by the threshing and separating assembly (118) and a distributor (128) configured to distribute the residual material discharged by the straw chopper (124) over a field.

### CROSS-REFERENCE TO RELATED APPLICATIONS

This application claims priority to German Patent Application No. 102024128415.3, filed Oct. 1, 2024, which is hereby incorporated by reference.

### FIELD OF THE DISCLOSURE

The present disclosure is directed to combine harvesters and, particularly, to combine harvesters having a distributor configured to distribute residual material discharged by a straw chopper over a field.

### BACKGROUND

Combine harvesters are agricultural machines which, in grain cultivation, are used to harvest different plants from a field. Combine harvesters are typically self-propelled, but some are pulled and supplied with power by a tractor. When the combine harvester moves over a field during the harvest, ripe crop is cut off by a harvester head on the front side of the combine harvester. The crop is moved into threshing and separating assemblies within the combine harvester, where grain is separated from the remaining plant material. The residual material (e.g., straw) is different from the grain, and the residual material is chopped in a straw chopper and expelled at the rear side of the combine harvester. In some instances, the chopped residual material is expelled together with chaff.

### EXEMPLARY EMBODIMENT

An exemplary embodiment described in more detail below is illustrated in the drawings. In the figures:

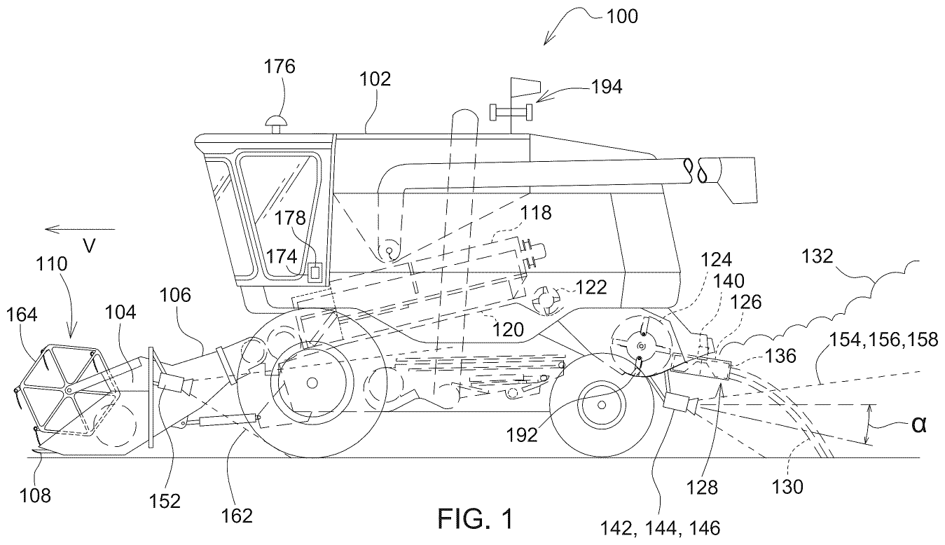

FIG. 1 shows a side view of an agricultural combine harvester with a distributor assembly for residual material,

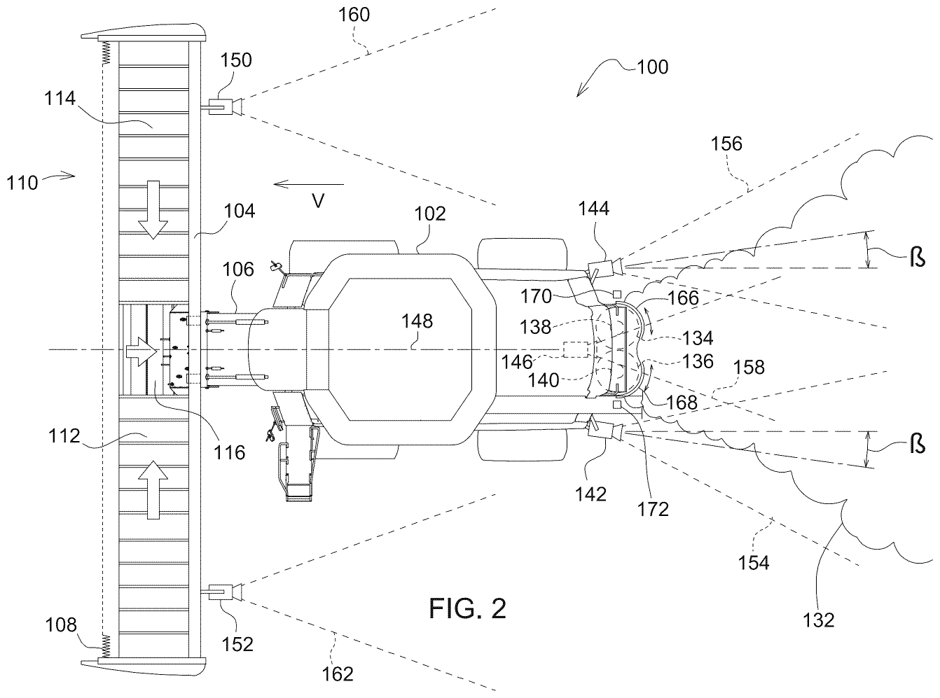

FIG. 2 shows a top view of the combine harvester from FIG. 1,

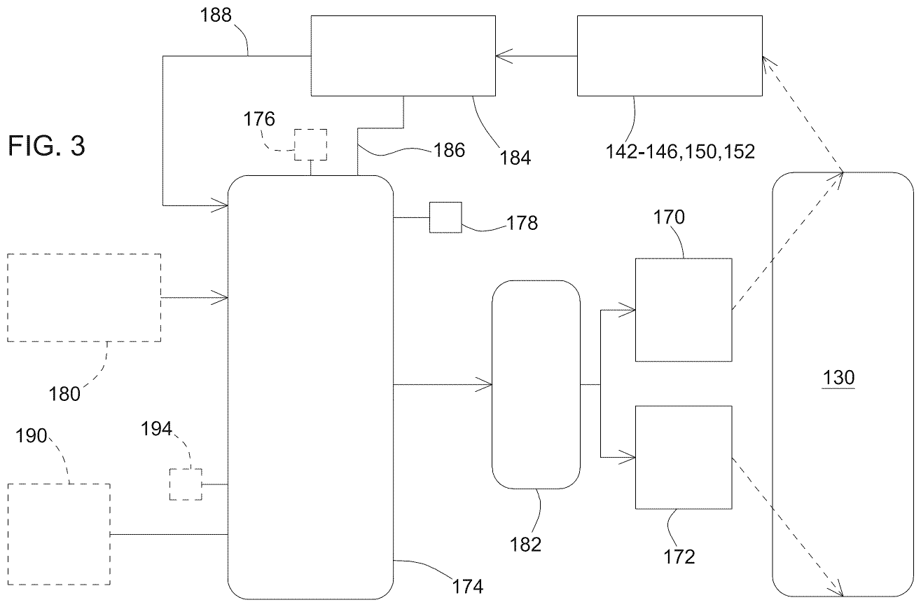

FIG. 3 shows a schematic of the control of the distributor assembly in a first operating mode,

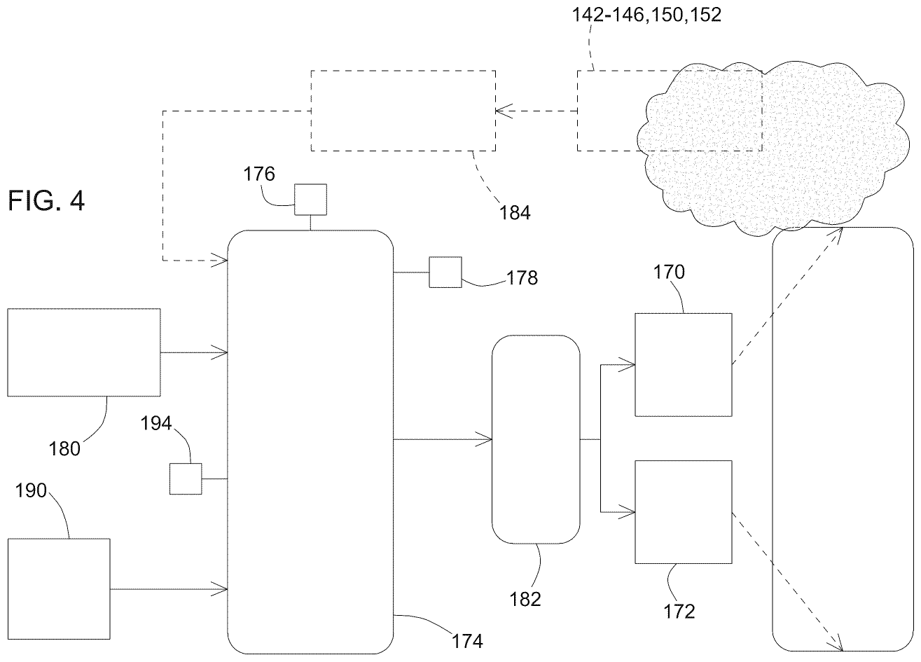

FIG. 4 shows a schematic of the control of the distributor assembly in a second operating mode, and

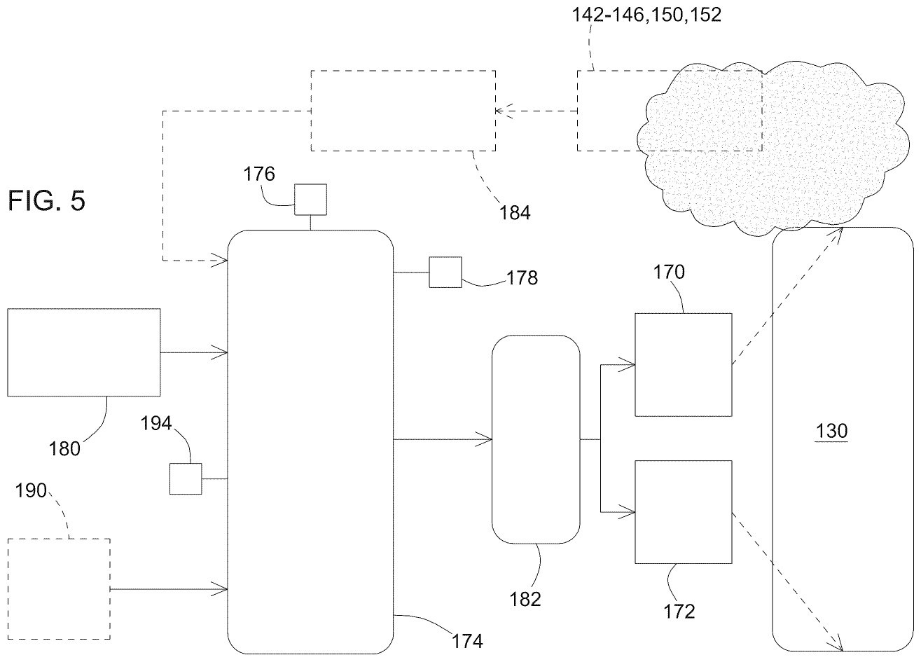

FIG. 5 shows a schematic of the control of the distributor assembly in a third operating mode.

### DETAILED DESCRIPTION

In some instances, residual material is to be distributed as uniformly as possible over the working width of the harvester head in order, firstly, to prevent crop residues getting into the remaining standing crop and, secondly, also to avoid regions of the field being loaded with more or less residual material than was harvested there. Since the residual material is distributed over a relatively large width and depends on various conditions such as, for example, wind influences, slope, and crop properties (type of crop, moisture content, degree of ripeness of the straw) and also on the level of processing in the straw chopper (cutting length, processing using rubbing bars and/or counter-blades), use is made of adjustable distributors with which the residual material is deflected more or less far laterally. A distinction is drawn between passive distributors (straw guide plates, cf. DE 101 34 141 A1) and active distributors with rotating discharge fans (see EP 1 570 726 A1). Such active distributors includes a left-hand discharge fan and a right-hand discharge fan, which rotate in opposite directions on parallel axes. The distribution of the residual material by the distributors depends on the rotational speed of the discharge fan. The greater the rotational speed of the discharge fan, the greater is also the resultant distribution width. In passive distributors, the distribution of the residual material over the field can be influenced by adjusting the alignment of the straw guide plates (DE 101 34 141 A1) and, in active distributors, by changing the rotational speed of the discharge fan (see EP 1 570 726 A1) and/or by adjusting the azimuthal position of casings which extend around the circumference of the discharge fan and form a break-off edge (EP 2 286 655 A1).

In some instances, apart from purely manual adjustment of the working parameters of the distributor to influence the lateral distribution of the residual material over the field, in principle two different practices for the automatic control of the distributors can be used. The first practice is based on sensors which are configured to detect the distribution actually achieved on the field and to control the distributors on that basis with the effect of the most uniform possible distribution of the residual material over the working width. In this regard, reference is made, for example, to EP 0 685 151 A1, EP 1 702 505 A1, EP 3 632 199 A1, DE 10 2023 134 654 A1 and DE 10 2014 014 049 A1. The are closed-loop controls in the narrower sense, since the control of the distribution of the residual material is based on a distribution detected by means of sensors and actually achieved on the field. A second practice provides for controlling the distributor only on the basis of data relating to environmental influences, such as standing crop maps and wind, without detecting the distribution achieved by sensors (EP 1 408 732 A1, EP 2 382 853 A2, EP 2 952 086 A1, DE 10 2014 005 904 A1, DE 10 2014 005 905 A1, DE 10 2014 005 906 A1). These are open-loop controls, without any sensor-based feedback of the result produced.

An advantage of closed-loop controls lie in the fact that, by means of the measurement by the sensor, it is also possible to take into account influences which are not included in the database of the control systems. However, the sensors do not operate reliably in all cases but can be impaired by external influences, such as poor visibility conditions in darkness, counter light or as a result of contamination of the objective. In these cases, the closed-loop controls are no longer usable. On the other hand, an advantage of open-loop controls is that they are also able to operate predictively. Predictive control provides for effecting a change in the setting of the actuator before a change, for example, of crop properties on the distribution of the crop, has any effect. On the other hand, the open-loop controls cannot take into account all conceivable external influences on the crop distribution.

DE 10 2011 082 052 A1 describes a transfer system for crop from a forage harvester to a transport vehicle which, in principle, operates on the basis of a camera but, for the case of the temporary failure thereof, reliance is placed on a movement model for the relative movement between the forage harvester and transport vehicle. Accordingly, there is a different context here.

In DE 10 2020 204 464 A1, a combine harvester is equipped with a control system which is controlled by means of a first or second predictive model. The first predictive model uses local sensor values in order to set working parameters of the combine harvester, and the second predictive model is based on a map with stored values. In each case a quality parameter is calculated for the two models and that which has the better quality parameter is used. The changeover is therefore based on the two predictive models and associated measured variables relating to the associated accuracies, e.g., based on calculations to set up the models and to evaluate their respective accuracy, which can be detected after a certain time, when a specific state has been established.

The present disclosure is directed to avoiding or at least reducing the aforesaid problems.

A combine harvester is equipped with a harvester head, a threshing and separating assembly, to which crop picked up from a field can be fed via the harvester head, a straw chopper for processing residual material which is discharged by the threshing and separating assembly, and a distributor for distributing the residual material discharged by the straw chopper over the field. The distributor includes one or more actuators for influencing the distribution of the residual material over the field, which actuator(s) can be controlled by a control unit, which can optionally be operated in one of the following operating modes: a first operating mode in which the control unit controls the actuator or actuators on the basis of the output signal from one or more sensor(s) for detecting the distribution of the residual material that is achieved on the field; a second operating mode, in which the control unit controls the actuator or actuators on the basis of operating data of the combine harvester and data relating to the crop and/or the topography of the field that is stored in a location-specific manner in a memory; and the control unit is configured to change automatically between the first operating mode and the second operating mode depending on a signal relating to the quality of the output signals from the sensor or sensors.

In other words, depending on the quality of the output signals from the sensor or the sensors, a changeover is made between a first operating mode in which closed-loop control of the at least one actuator is carried out to influence the distribution of the residual material over the field on the basis of the sensor or sensors, and a second operating mode in which open-loop control of the at least one actuator is carried out to influence the distribution of the residual material over the field on the basis of operating data of the combine harvester and data relating to the crop and/or the topography of the field that is stored in a location-specific manner in a memory. Work is carried out in this way with closed-loop control as long as the quality of the signals from the sensor or the sensors permits but falls back automatically on open-loop control should the quality no longer suffice. A calculation of a predictive model and the associated measured variable for the model accuracy is not needed.

FIG. 1 shows a self-propelled combine harvester 100 which is used in cereal cultivation to harvest a multiplicity of different crops from a field. When the combine harvester 100 moves over a field during harvesting operation, ripe crop is cut off by a harvester head 110 on the front side of the combine harvester 10 by using a cutter bar 108. The crop is then transferred through a feeder house 106 to a threshing and separating assembly 118 within the combine harvester 100, where grain is separated from the crop by threshing concaves and separator screens 120. The clean grain obtained is stored in a grain tank 102 arranged on the combine harvester 100 until it can be unloaded to be transported away. The residual material that is different from the grain, which includes straw and possibly chaff, is conveyed away from the threshing and separating assembly 118 by a conveyor drum 122 and is comminuted by a straw chopper 124 and then, behind the combine harvester 100, scattered over a wide area by a distributor 128. For greater distribution widths, use is usually made of distributors 128 which comprise discharge fans 134 and 136 rotating in opposite directions. Although the threshing and separating assembly 118 is designed here as an axial threshing and separating rotor, it could be implemented by a tangential thresher drum with downstream straw walker, one or more tangential separator drums, or one or more axial separator rotors.

As shown in FIG. 2, the harvester head 110 comprises two conveyor belts 112, 114 running in the transverse direction and, between them, a conveyor belt 116 running toward the rear, which transfers the crop into the feeder house 106. A reel 164 is attached above the conveyor belts 112, 114, 116.

The combine harvester 100 shown in FIG. 1 is provided with a distributor 128 of the spreader-disk type, which is attached to the rear side of the combine harvester 100. The distributor 128 includes a right-hand discharge fan 134 and a left-hand discharge fan 136, which rotate in opposite directions about parallel axes, as illustrated in FIG. 2. The axes are normally arranged substantially vertically but can be inclined forward or rearward in order to optimize the output of the distributor 128. The discharge fans 134 and 136 are arranged underneath an upper cover plate 126, open toward the bottom in the embodiment illustrated, and have paddles extending downward which engage in the residual material. The discharge fans 134 and 136 are configured to pick up residual material from the straw chopper 124 in a flow which is approximately parallel to its rotational plane or slightly below the same. These discharge fans 134, 136 are typically driven by actuators 138, 140 in the form of hydraulic or electric motors but could also be driven by mechanical drive elements. In some instances, the discharge fans 134, 136 have an adjustable rotational speed.

The distributor 128 is configured to receive residual material from the combine harvester 100 and to distribute it uniformly over a wide area of the field behind the combine harvester 100, as shown in FIGS. 1 and 2. In operation, residual material from the straw chopper 124 is expelled in the direction of the discharge fans 134, 136 rotating in opposite directions. The discharge fans 134, 136 receive the residual material and scatter it rearwardly and outwardly from the combine harvester 100 in a flow 130, in order to achieve a uniform distribution of the residual material over the field. This additionally produces a dust cloud 132 of chaff and other lightweight particles of the residual material.

In general, the distribution width of the residual material on the right of a longitudinal mid-plane 148 of the combine harvester 100 is assigned to the right-hand discharge fan 134 and, analogously, the distribution width of the residual material on the left-hand side of the longitudinal mid-plane 148 of the combine harvester 100 is assigned to the left-hand discharge fan 136. When the residual material is scattered by the distributor 128, it is desirable that it covers only the region of the field which the combine harvester 100 has just cut by means of the harvester head 110. External conditions, such as side winds and lateral inclinations, can influence the position of the center of gravity of the distribution, which leads to residual material being distributed in uncut regions, which results in a strip with undesired coverage. When the combine harvester 100 turns back and cuts off the crop on which residual material has been scattered, the residual material is picked up in strips and processed again in the combine harvester 100. When the residual material is scattered again under the aforementioned external conditions, a strip of the field that is produced on the side of the combine harvester 100 that faces the wind or the hill is left uncovered. In addition, crop conditions, such as the type of crop and the moisture content, can influence the distribution width of the distributor 128.

The lateral distribution of the residual material can be controlled in various ways. One possibility is to change the rotational speed of the discharge fans 134, 136 by controlling the actuators 138, 140. Alternatively or additionally, the azimuthal position of a casing 166, 168 of the discharge fan 134, 136 can be adjusted by actuators 170, 172, which are each rotated by the actuators 170, 172 about an axis coaxial with the rotational axis of the discharge fans 134, 136 or parallel thereto, as indicated in FIG. 2 by the arrows. The casing 166, 168 defines the position of an angle up to which the discharge fans 134, 136 discharge the residual material toward the outside, i.e. a tear-off edge. The distribution of the residual material on the field can, thus, be controlled by means of the actuators 138, 140 and/or 170, 172. Should the combine harvester 100 not be equipped with discharge fans but with a straw distributor with straw guide plates, the angle of the straw guide plates can be adjusted by an actuator (not shown).

In order to detect the actually achieved distribution of the residual material, a series of electro-optical sensors 142, 144, 146, 150, 152 are provided, which detect the flow 130 of the residual material at the rear of the discharge fans 134, 136. The sensors 142, 144, 146, 150, 152 include cameras or other sensors such as radar sensors or laser range-finders, which each scan a one- or two-dimensional angular range, or in each case a plurality of fixedly attached sensors which are sensitive in a specific angular range are used. The angular ranges 154, 156, 158, 160, 162, detected by the sensors 142, 144, 146, 150, 152 extend at least horizontally and optionally also vertically. The sensors 142, 144, and 146 are arranged laterally beside one another on the rear side of the combine harvester 100, underneath the discharge fans 134, 136, and the sensors 150, 152 are arranged on the rear side of the harvester head 110. Further details in this regard are described in EP 3 639 647 A2, the disclosure of which is included by reference in the present documents. Possible alignments of the optical axes of the sensors 142, 144 are illustrated in FIGS. 1 and 2 by the angles α and β.

It should be noted that some or all of the sensors could be arranged at any desired other locations, for example on a rear-view mirror of the cab of the combine harvester 100 or at the top on its rear side or on a drone which flies somewhat behind the combine harvester 100.

The sensors 142, 144, 146, 150, 152 are connected to a control unit 174 which, in turn, controls the actuators 170, 172 and/or 138, 140. In addition, the control unit 174 is connected to a position determining device 176, which receives signals from satellites of a global navigation system such as GPS or Eureka, and to a memory 178 for programs and data.

The functioning of the control unit 174 is illustrated in FIGS. 3 to 5. The control unit 174 controls a driver 182, which, in turn, controls the actuators 170, 172 (and/or predefines or controls the speed of the actuators 138, 140). In the operating mode of FIG. 3, this control in principle operates exclusively and only on the basis of the output signals from the sensors 142, 144, 146, 150 and 152, which are processed by an (image) processing system 184. The processing system 184 could also be co-integrated into the control unit 174. For example, the processing system 184 is configured to generate a signal 188 relating to the lateral distribution of the residual material on the field, for example in the form of a histogram of the residual crop quantities in the transverse direction, and to feed the signal 188 to the control unit 174. Here, use can be made of a suitable model in order to derive the achieved distribution on the ground from the output signals from the sensors 142, 144, 146, 150, 152 which detect only the residual material in the flight (cf., for example, DE 10 2014 014 049 A1 or EP 3 932 172 A1). If one or more of the sensors 142, 144, 146, 150, 152 interact or interacts directly with the residual material lying on the ground, the evaluation may be somewhat simpler, since the residual material is then detected more directly.

The processing system 184 additionally outputs to the control unit 174 a signal 186 which contains information about the quality (reliability) of the signal 188 to the control unit 174. Accordingly, the output signal from the sensors 142-146, 150, 152 is monitored by the processing system 184 as to whether the sensors 142, 144, 146, 150, 152 are capable of distinguishing the residual material from other detected features. To this end, for example, the contrast of the output signals can be examined, and it is also possible to check whether the output signals are plausible, which is also used analogously for the signal 188 that relates to the calculated distribution of the residual material on the field. The signal 186 can be binary and, accordingly, can provide information as to whether the quality of the signal 188 is adequate or not, or include any desired number of intermediate stages, for example a signal quality in the form of percentages.

By using the signal from the processing system 184, in the (first) operating mode of FIG. 3 the control unit 174 is capable of controlling the actuators 170, 172 and/or 138, 140 via the driver 182 as long as the quality indicated by the signal 186 lies above a specific threshold. There is, therefore, closed-loop control, with feedback from the sensors 142, 144, 146, 150, and 152. The actuators 170, 172 and/or 138, 140 are accordingly controlled in a manner known per se, cf. EP 0 685 151 A1, EP 1 702 505 A1, EP 3 632 199 A1, DE 10 2023 134 654 A1 and DE 10 2014 014 049 A1, in such a way that the residual material is distributed as uniformly as possible over the cutting width harvested by the combine harvester 100 but not beyond the same.

The control unit 174 is additionally further supplied via a communication system (e.g., bus system, cf. ISO 11783) 180 of the combine harvester 100 with further information about operating values of the combine harvester 100, such as throughput and moisture content of the crop, the position of a bar with counter-cutting blades 192 that is adjustable between an active operating position and an inactive non-operating position and, if appropriate, the type of crop processed and/or the power consumed by the rotor of the straw chopper 124 and its rotational speed and/or the total power provided by the drive motor of the combine harvester 100. In addition, the control unit 174 can also be supplied via the communication system 180 or directly with signals relating to the steering angle of the steerable rear wheels of the combine harvester 100. In addition, further data relating to the straw chopper 124 can be present in the control unit 174, such as the number and type of the chopper blades and dimensions.

The control unit 174 is additionally connected to a memory 190, in which maps relating to the field are stored. The maps may include maps relating to the expected yield, the expected moisture content of the crop, and, optionally, the type of crop and/or the topography of the field. These maps can be based on yield and moisture content measurements generated during preceding harvests and/or based on remote-sensing data, for example from satellites, drones, etc., and/or plant growth models or generated in any other desired way. In addition, the control unit 174 is supplied with signals relating to the respectively prevailing wind (strength and direction), which can be detected by means of a wind sensor 194 or transmitted to the combine harvester 10 in a wire-free manner, and the inclination of the respectively covered terrain, be it by using the maps from the memory 190 relating to the topography of the field and the current position by using the signals from the position determining device 176, or by using an inclination sensor of the combine harvester 100, which can be integrated in the position determining device 176.

The signals described in the two preceding paragraphs are in principle not needed in the first operating mode of FIG. 3, and the signal sources are therefore shown dashed in FIG. 3.

If, on the other hand, the quality of the output signals from the sensors 142, 144, 146, 150, and 152 indicated by the signal 186 points to the fact that the quality of these output signals lies below the threshold and the output signals are accordingly not sufficiently powerful for the control of the actuators 170, 172 and/or 138, 140 to be based thereon, which, for example, can be caused by contamination of the sensors 142, 144, 146, 150, and 152, for example as a result of dust from the dust cloud 132, from counter-light, a lack of light at twilight, or at night, or unfavorable wind, which drives the dust cloud 132 between the sensors and the flow 130 of the residual material, the control unit 174 operates in the second operating mode according to FIG. 4. There, the control of the actuators 170, 172 and/or 138, 140 is based on some or a plurality or all of the aforementioned data obtained via the communication system 180 and the data retrieved from the memory 190 by using the position determining device 176 and also the signals from the wind sensor 194 but not on the basis of the sensors 142-146, 150, 152 (shown dashed). There is no closed-loop control. Instead, open-loop control of the actuators 170, 172 and/or 138, 140 is used. For example, the actuators 170, 172 and/or 138, 140 are controlled without any information about the achieved result of the controlled system. Here, use can be made of a model which models the movement and/or deposition of the residual material through the flow 130 on the ground on the basis of the received data, and pre-definitions for the actuators 170, 172 and/or 138, 140 are created on this basis. For example, the procedure can be similar to the first predictive model according to DE 10 2020 204 464 A1. By using the steering angle, it is possible to take into account by means of the model that, when traveling in a curve in the standing crop, without any compensation of the steering angle, the residual material tends to be over-distributed on the outside of the curve and under-distributed on the inside (cf. EP 2 952 086 A1, DE 10 2014 005 904 A1, DE 10 2014 005 905 A1, DE 10 2014 005 906 A1).

On the other hand, if the quality of the output signals from the sensors 142, 144, 146, 150, and 152 indicated by the signal 186 point to the fact that the quality of these output signals lies below the threshold, no data relating to the field is found in the memory 190, the control unit 174 automatically selects a third operating mode, as shown in FIG. 5. Therefore, the control of the actuators 170, 172 and/or 138, 140 is carried out only by using the data obtained via the communication system 180 and, if appropriate, relating to the wind and/or the steering direction. There is no closed-loop control here either; instead open-loop control of the actuators 170, 172 and/or 138, 140 is used. The actuators 170, 172 and/or 138,140 are controlled without any information about the achieved result of the controlled system. The memory 190 is shown dashed, since it is not used. The procedure of the third operating mode is therefore less refined as compared with the second operating mode, since the maps from the memory 190 are not present. On the other hand, the signals from the local wind sensor 194 relating to the inclination and/or steering angle of the combine harvester 100 are likewise used. The third operating mode corresponds approximately to the procedure according to EP 1 408 732 A1, EP 2 382 853 A2, EP 2 952 086 A1, DE 10 2014 005 904 A1, DE 10 2014 005 905 A1 or DE 10 2014 005 906 A1.

It should be noted that a mixed form of the first and second and third operating mode would be conceivable. Depending on the signal 186 (non-binary in this case), the signals from the sensors 142, 144, 146, 150, 152 on the one hand and the data from the communication system 180 and possibly from the memory 190 and relating to the inclination of the combine harvester 100 and from the wind sensor 194 relating to the steering angle on the other hand are incorporated in weighted form in the generation of the control signals to the actuators 170, 172 and/or 138, 140. For example, if the quality of the output signals from the sensors 142, 144, 146, 150, 152 is 50% according to signal 186, the signals from the sensors 142-146, 150, 152 and from the communication system 180 and possibly the memory 190 and relating to the inclination of the combine harvester 100 and from the wind sensor 194 are used equally for generating the control of the actuators 170, 172 and/or 138, 140.

It would further be conceivable, by means of the control unit 174 in the first operating mode, to use the signals from the memory 190 and relating to the inclination of the combine harvester 100 and from the wind sensor 194 and relating to the steering angle in combination with those from the sensors 142, 144, 146, 150, 152 in order to carry out closed-loop control by using the signals from the sensors 142, 144, 146, 150, 152 but to take account of the signals from the memory 190 and optionally relating to the inclination of the combine harvester 100 and from the wind sensor 194 and relating to the steering angle in a predictive manner as disturbance variables during the creation of the actuating signals to the actuators 170, 172 and/or 138, 140. Thus, for example, by using appropriate data from the memory 190, it is possible to take account of an immediately impending change in the crop density or moisture content even before its effect regarding the crop distribution can be detected by the sensors 142, 144, 146, 150, 152. In an analogous way, traveling in a curve which is to be expected can be detected and taken into account in a predictive manner by using a path plan recorded in the map in the memory 190.

Furthermore, there is the possibility that the control device 174 can be designed to be self-teaching. Then, signals from the communication system 180 and possibly the memory 190 and relating to the inclination of the combine harvester 100 and from the wind sensor 194 needed in the first operating mode and also needed in the second and third operating mode would be fed to the control device 174, and the control device 174 learns what effect these signals have on the actuating signals to the actuators 170, 172 and/or 138, 140. As a result, the second and possibly also the third operating mode can be placed on a more secure basis than in a non-self-learning system, in that the relationships learned are taken into account there. Finally, the control device 174 can also store data relating to the achieved coverage of the ground obtained by using the sensors 142, 144, 146, 150, 152 in a location-specific manner, in order that they can be taken into account in the following processing operation.

### Example of the Present Disclosure:

An example combine harvester (100) is equipped with a harvester head (110); a threshing and separating assembly (118), to which crop picked up from a field can be fed via the harvester head (110); a straw chopper (124) for processing residual material which is discharged by the threshing and separating assembly (118), and a distributor (128) for distributing the residual material discharged by the straw chopper (124) over the field, wherein:
the distributor (128) includes one or more actuators (138, 140, 170, 172) for influencing the distribution of the residual material over the field,
the actuator or actuators (138, 140, 170, 172) can be controlled by a control unit (174), which can optionally be operated in one of the following operating modes:
a first operating mode, in which the control unit (174) controls the actuator or actuators (138, 140, 170, 172) on the basis of the output signal from one or more sensor(s) (142, 144, 146, 150, 152) for detecting the distribution of the residual material that is achieved on the field,
a second operating mode, in which the control unit (174) controls the actuator or actuators (138, 140, 170, 172) on the basis of operating data of the combine harvester (100) and data relating to the crop and/or the topography of the field that is stored in a location-specific manner in a memory (190),
and the control unit (174) is configured to change automatically between the first operating mode and the second operating mode depending on a signal (186) relating to the quality of the output signals from the sensor or sensors (142, 144, 146, 150, 152).

What is claimed is:

1. A combine harvester comprising a harvester head, a threshing and separating assembly configured to receive crop picked up from a field via the harvester head, a straw chopper configured to process residual material which is discharged by the threshing and separating assembly, and a distributor configured to distribute the residual material discharged by the straw chopper over the field,
wherein the distributor includes one or more actuators configured to influence a distribution of the residual material over the field,
wherein the one or more actuators are configured to be controlled by a control unit, the control unit is configured to be operated according to a first operating mode or a second operating mode
wherein, in the first operating mode, the control unit is configured to control the one or more actuators on the basis of an output signals from one or more sensor, the one or more sensors configured to detect the distribution of the residual material that is achieved on the field,
wherein, in the second operating mode, the control unit is configured to control the one or more actuators on the basis of operating data of the combine harvester and data relating to the crop or the topography of the field that is stored in a location-specific manner in a memory, and wherein the control unit (174) is configured to change automatically between the first operating mode and the second operating mode in response to a first signal relating to the quality of the output signals from the one or more sensors.

2. The combine harvester of claim 1, wherein the control unit is configured to select the first operating mode automatically if the first signal relating to the quality of the output signals from the one or more sensors meets or exceeds a threshold, and to select the second operating mode automatically if the first signal relating to the quality of the output signals from the one or more sensors does not meet the threshold.

3. The combine harvester of claim 1, wherein the control unit is configured to be operated in a third operating mode, and
wherein, in the third operating mode, the control unit is configured to control the one or more actuators on the basis of operating data of the combine harvester and is configured to change automatically to the third operating mode in response to a lack of location-specifically stored data relating to the crop or the topography of the field.

4. The combine harvester of claim 3, wherein control of the one or more actuators is closed-loop control, and
wherein the closed-loop control includes selecting control based on the first operating mode, the second operating mode, or the third operating mode in response to the first signal relating to the quality of the output signals from the one or more sensors, the output signals from the one or more sensors, the operating data from the memory, or the data relating to the inclination of the field, the data relating to the wind, or the data relating to the steering angle of the combine harvester (100) in response to a quality of each of first signal and the output signals.

5. The combine harvester of claim 3, wherein the control device is self-learning, wherein, using self-learning, the control device signals utilizes the output signals from the one or more sensors and the first signal relating to the quality of the output signals from the one or more sensors to determine an effect the first signal and the output signals have on control of the one or more actuators, and the control device (174) is configured to take account of the effect in the second operating mode or the third operating mode.

6. The combine harvester of claim 1, wherein the one or more sensors include a camera,
wherein the output signals from the camera are processed by an image processing system
wherein the image processing system is configured to generate a second signal relating to a lateral distribution of the residual material on the field based on the output signals from the camera.

7. The combine harvester of claim 6, wherein the image processing system is further configured to generate the signal based on a quality of the output signals from the one or more sensors.

8. The combine harvester of claim 6, wherein the image processing system is further configured to monitor the output signals from the one or more sensors and to determine, based on the output signals, whether one or more sensors is capable of distinguishing the residual material from other detected features.

9. The combine harvester of claim 1, wherein, in the second operating mode, the control device is configured to control the one or more actuators based wind data, or the inclination of the field, or a steering angle of the combine harvester.

10. The combine harvester (100) as claimed in claim 9, wherein, in a third operating mode, the control device (174) is configured to control the one or more actuators based on the operating data of the combine harvester (100) and based on data relating to the wind, inclination of the field, or a steering angle of the combine harvester.

11. The combine harvester of claim 1, wherein the operating data of the combine harvester includes data relating to throughput of the crop, moisture content of the crop, a position of a bar with counter-cutting blades of the straw chopper that is adjustable between an active operating position and an inactive non-operating position, a type of crop processed, a power consumed by the rotor of the straw chopper, a rotational speed of the straw chopper, a total power provided by a drive motor of the combine harvester, a number of chopping blades of the straw chopper, a type of the chopping blades of the straw chopper, or a dimension of the straw chopper, and
wherein the data relating to the crop that is stored in a location-specific manner in the memory includes: yield data, crop moisture content data, or type of crop data.

12. The combine harvester of claim 1, wherein the one or more actuators is configured to influence one or more of the following parameters: a rotational speed of a discharge fan, a position of a casing of the discharge fan), or a position of straw guide plates of a passive distributor.
